(19) United States
(12) Patent Application Publication
(10) Pub. No.: US 2024/0222002 A1
(43) Pub. Date: Jul. 4, 2024

(54) MULTI-LAYER POWER TRANSFORMER WITH IMPROVED AC AND DC RESISTANCE

(71) Applicant: Infineon Technologies Austria AG, Villach (AT)

(72) Inventors: Gerald Deboy, Klagenfurt (AT); Christian Rainer, Magdalensberg (AT)

(21) Appl. No.: 18/092,605

(22) Filed: Jan. 3, 2023

(51) Int. Cl. H01F 27/40; H01F 27/24; H01F 27/30

(52) U.S. Cl. CPC H01F 27/40; H01F 27/24; H01F 27/306

(57) ABSTRACT

A multi-layer power converter assembly includes a transformer in which a secondary winding is magnetically coupled to a primary winding of the transformer. The multi-layer power converter assembly further includes an intermediary layer such as including a substrate disposed between the primary winding and the secondary winding. A circuit (such as one or more circuit components) disposed in the intermediary layer is coupled between a first node of the secondary winding and a second node of the secondary winding. The novel power converter assembly as discussed herein provides new degrees of freedom with respect to placing secondary side windings, paralleling them, and reducing hence AC and DC resistances in a respective power converter assembly. The power converter assembly supports more power dense transformers through vertical integration rather than spreading into the x-y plane through matrix transformer constructions.

### BACKGROUND

As its name suggests, a conventional switched-capacitor converter converts a received input voltage into an output voltage.

With continuous increases in power density in numerous application segments ranging from mobile phone chargers to server and telecom power supplies and On-board chargers, galvanic isolated power transfer through high frequency transformers becomes ever more challenging. Transitioning from Litz-wire based, wounded transformer construction into planar transformer concepts, where primary and secondary windings are integrated into one or several PCBs brings already significant benefits.

Calculations have shown, that planar transformers are not only better in power density but also with respect to overall power losses from around 500 kHz upward.

At high switching frequencies, losses both from AC resistances as well as DC resistances do matter. Specifically, the construction of primary and secondary side windings and the physical arrangement of synchronous rectification devices and output capacitors are crucially important. The implementation of a high-frequency planar transformer given in Gustavo C. Knabben, Grayson Zulauf, Jannik Schäfer, Johann W. Kolar, Matthias J. Kasper, Jon Azurza Anderson and Gerald Deboy, “Conceptualization and Analysis of a Next-Generation Ultra-Compact 1.5-kW PCB-Integrated Wide-Input-Voltage-Range 12V-Output Industrial DC/DC Converter Module”, Electronics 2021, 10, 2158, is currently one of the best state-of-the-arts.

### BRIEF DESCRIPTION

In a conventional power converter construction, primary side windings with several turns are put into the inner layers of the PCB (Printed Circuit Board) and secondary side windings on top and bottom of the PCB. Additionally, shielding layers are potentially integrated into a respective assembly to reduce the coupling capacitance between primary to secondary side windings. Some layers may be left intentionally void to further reduce coupling capacitances.

Further, in a conventional construction, the key disadvantage is, that only top and bottom layers of a circuit board are accessible to place capacitors and synchronous rectification devices. To reduce termination losses these elements need to be placed as close as possible to the secondary side winding. Having only two layers available increases the DC resistance and potentially enhances the cost of the planar transformer due to requirements on thicker copper layers.

This disclosure includes novel ways of providing improved performance of a voltage converter generating a corresponding output voltage. For example, this disclosure includes a novel construction of a transformer implementation, allowing new degrees of freedom with respect to placing secondary side windings, paralleling them, and reducing hence AC and DC resistances in a respective power converter assembly. This disclosure further enables more power dense transformers through vertical integration rather than spreading into the x-y plane through matrix transformer constructions.

More specifically, according to one example, an apparatus (such as a power supply, multi-layer transformer assembly, multi-layer power converter assembly, etc.) includes: a primary winding; a secondary winding magnetically coupled to the primary winding; and an intermediary layer disposed between the primary winding and the secondary winding. A circuit is disposed in the intermediary layer; the circuit is electrically coupled to the secondary winding.

The circuit may be directly coupled between a first node of the secondary winding and a second node of the secondary winding.

The circuit may be configured to control a flow of current through the secondary winding.

The circuit may include any circuit components such as a capacitor and a switch disposed in series. For example, the capacitor may be coupled between a first node of the circuit and a second node of the circuit; the switch may be coupled between the second node of the circuit and a third node of the circuit; the first node of the circuit may be directly coupled to a first node of the secondary winding; and the third node of the circuit may be directly coupled to a second node of the secondary winding. Further, the circuit may include a first facing and a second facing; the first node of the circuit and the third node of the circuit may be disposed on the first facing of the circuit; and the second node of the circuit may be disposed on the second facing of the circuit, the second facing opposite the first facing.

Yet further, the circuit may be configured to include a vertical capacitor and a vertical field effect transistor (such as a vertical switch). In such an instance, a first node of the vertical capacitor may be directly coupled to a first node of the switch via an electrically conductive path; a second node of the vertical capacitor may be directly coupled to a first node of the secondary winding; and a second node of the vertical switch may be directly coupled to the second node of the secondary winding. The primary winding can be configured to reside within a first plane; the second winding can be configured to reside in a second plane, the second plane substantially parallel to the first plane; the intermediary layer can be configured to resides between the first plane and the second plane.

In still further examples as discussed herein, the circuit may include a capacitor and a switch; a combination of the secondary winding, the switch, and the capacitor may be connected in series. The combination of the secondary winding, the switch, and the capacitor may form a series circuit loop.

The intermediary layer may be configured to include a substrate; the primary winding may be affixed to a first surface of the substrate; and the secondary winding may be is affixed to a second surface of the substrate.

A core of magnetic permeable material can be configured to pass through the intermediary layer; both the primary winding and the secondary winding may be wrapped around the magnetic permeable material of the core.

The intermediary layer may include a substrate. In such an instance, the circuit is disposed in an inlay of the substrate.

Still further, a reference voltage node disposed in a circuit layer in which the primary winding resides; and wherein the circuit is disposed between the reference voltage node and the secondary winding.

The multi-layer-layer transformer assembly as discussed herein may further include: a reference voltage node disposed in a circuit layer in which the primary winding resides, the reference node not electrically connected to the primary winding; the circuit includes a first circuit component, a first surface node of the first circuit component electrically coupled directly to the reference voltage node, a second surface node of the first circuit component electrically coupled directly to the secondary winding.

Further examples as discussed herein include a multiple-layer transformer assembly comprising: a primary winding; a first secondary winding magnetically coupled to the primary winding; a second secondary winding magnetically coupled to the primary winding; a first substrate separating the primary winding and the first secondary winding, the first substrate including a first inlay; a first circuit disposed in the first inlay; a second substrate separating the primary winding and the second secondary winding, the second substrate including a second inlay; and a second circuit disposed in the second inlay.

The primary winding may include a first primary winding portion electrically coupled to a second primary winding portion; and the first substrate and the second substrate may be disposed between the first primary winding portion and the second primary winding portion.

The first circuit may include a first switch. Control of the first switch produces an output voltage via first current supplied by the first secondary winding. The second circuit may include a second switch. Control of the second switch produces the output voltage via second current supplied by the second secondary winding.

The multi-layer transformer assembly may further include: a circuit path operative to directly connect the first secondary winding and the second secondary winding in series.

A method as discussed herein includes: fabricating an intermediary layer between a primary winding and a secondary winding of a multi-layer transformer assembly to include a circuit operative to control flow of current through the secondary winding; and providing electrical coupling of the circuit between a first node of the secondary winding and a second node of the secondary winding.

Implementations of the novel power converter as discussed herein are useful over conventional techniques. For example, in contrast to conventional techniques, the multi-layer power converter assembly as discussed herein provides or more nodes of a power converter with respect to conventional techniques.

These and other more specific examples are disclosed in more detail below.

In addition to potentially being implemented as an analog controller and corresponding analog circuitry/components as described herein, note that any of the resources as discussed herein can include one or more computerized devices, apparatus, hardware, etc., execute and/or support any or all of the method operations disclosed herein. In other words, one or more computerized devices or processors can be programmed and/or configured to operate as explained herein to carry out the different examples as described herein.

Yet other examples herein include software programs to perform the steps and/or operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes a computer readable storage medium and/or system having instructions stored thereon to facilitate fabrication office action a power converter assembly as discussed herein. The instructions, when executed by computer processor hardware, cause the computer processor hardware to: fabricate a circuit in an intermediary layer between a primary winding and a secondary winding of a multi-layer power converter assembly; and providing electrical coupling of the circuit between a first node of the secondary winding and a second node of the secondary winding.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

Note further that although examples as discussed herein are applicable to controlling switches in a power supply operable to generate an output voltage, the concepts disclosed herein may be advantageously applied to any other suitable voltage converter topologies.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example general diagram illustrating a power converter assembly as discussed herein.

FIG. 2 is an example diagram illustrating a power converter circuit as discussed herein.

FIGS. 3A and 3B are example diagrams illustrating different top views of a secondary winding and corresponding circuitry as described herein.

FIGS. 4A and 4B are example side view diagrams illustrating implementation of circuitry between a primary winding and a secondary winding as described herein.

FIG. 5 is an example side view diagram illustrating implementation of circuitry in an intermediary layer such as between a primary winding layer and a secondary winding layer as described herein.

FIG. 6 is an example side view diagram illustrating implementation of multiple different primary and secondary winding layers of a multi-layer power converter assembly to provide power conversion as described herein.

FIG. 7 is an example diagram illustrating different types of circuit populated in a respective intermediary layer to provide power conversion as described herein.

FIG. 8 is an example diagram illustrating a power converter circuitry as described herein.

FIG. 9 is an example diagram illustrating current flow through different windings of the power converter circuitry as described herein.

FIG. 10 is an example side view diagram illustrating stacking of multiple different power converter circuitry is to provide power conversion as described herein.

FIGS. 11A and 11B are example top view diagrams of different layers of a power converter as described herein.

FIG. 12 is an example side view diagram illustrating implementation of multiple cavities at different intermediary layers of a power converter assembly to provide power conversion described herein.

FIG. 13 is an example top view diagram illustrating different layers of a respective power converter assembly and corresponding circuitry as described herein.

FIG. 14 is an example diagram of a power converter circuit as described herein.

FIGS. 15A and 15B are example top view diagrams of a power converter assembly as discussed herein.

FIG. 16 is an example side view diagram illustrating implementation of intermediary layer such as including a inlay in a substrate to implement a power converter assembly as described herein.

FIG. 17 is an example top view diagram illustrating different layers of a respective power converter assembly and corresponding circuitry as described herein.

FIG. 18 is an example diagram illustrating computer architecture operable to execute one or more operations as discussed herein.

FIG. 19 is an example diagram illustrating a general method of producing an assembly as discussed herein.

The foregoing and other objects, features, and advantages of examples herein will be apparent from the following more particular description herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A multi-layer power converter assembly as discussed herein includes a transformer in which a secondary winding is magnetically coupled to a primary winding in the transformer. The multi-layer power converter assembly further includes an intermediary layer including a substrate disposed between the primary winding and the secondary winding. The intermediary layer and corresponding substrate may include an inlay (such as a void, cavity, opening, etc.). A circuit disposed in the intermediary layer is coupled between a first node of the secondary winding and a second node of the secondary winding. The configuration of the novel power converter assembly as discussed herein provides new degrees of freedom with respect to placing secondary side windings, paralleling them with one or more primary windings, and reducing hence AC and DC resistances in a respective power converter assembly between the circuitry and the secondary side windings. In different applications, the power converter assembly supports more power dense transformers through vertical integration rather than spreading into the X-Y surface plane (horizontal plane) through matrix transformer constructions.

Accordingly, one aspect of the present disclosure includes implementation of a novel transformer construction using one or more intermediary layers (such as inlays or alternatively chip-embedding techniques) to integrate capacitors and synchronous rectification elements within the PBC. This arrangement helps significantly to reduce AC termination losses and provides the option to integrate paralleled secondary windings including embedded switches and capacitors, to close the electrical loop as close (in distance, such as shorter electrically conductive paths between components) as possible, in each of one or more layers rather than implement non-winding (such as capacitors, switches, etc.) or winding circuitry only on top and bottom layers which in turn drastically reduces the DC resistance as discussed herein.

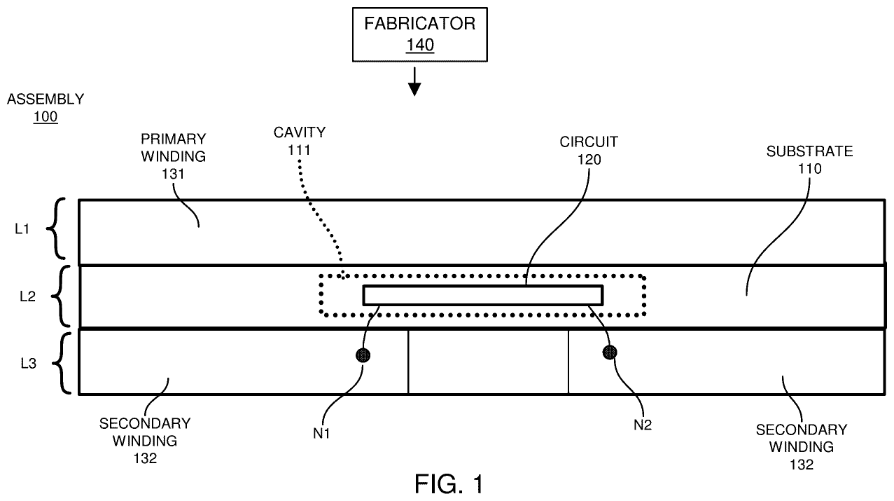

Now, more specifically, FIG. 1 is an example general diagram illustrating a multi-layer power converter assembly as discussed herein.

As shown in this example, the fabricator 140 fabricates a multi-layer power converter assembly 100 to include multiple layers such as layer L1, layer L2, and layer L3 and corresponding circuit components. Layer L2 is an intermediary (such as in-between) layer disposed between the layer L1 and layer L3.

Each of the different layers of the multilayer power converter assembly 100 can be configured to include different components associated with a respective implementation of a power converter. For example, layer L1 of the multilayer power converter assembly 100 can be configured to include a primary winding 131 of a transformer associated with the multi-layer power converter assembly 100. Layer L3 of the multilayer power converter assembly 100 can be configured to include a secondary winding 132 of the transformer.

As further discussed herein, the secondary winding 132 may be magnetically coupled to the primary winding 131 of the transformer. The substrate 110 such as in the intermediary layer L2 provides separation of the layer L1 (primary winding 131) and layer L3 (secondary winding 132).

As further shown, the intermediary layer L2 and/or corresponding substrate 110 of the multilayer power converter assembly 100 can be configured to include a respective cavity 111 (such as inlay, void, etc.). The cavity 110 associated with the intermediary layer L2 may or may not extend from one surface of the intermediary layer L2 (or substrate 110) to another surface of the intermediary layer L2 (or substrate 110).

The circuit 120 including one or more circuit components such as semiconductor chips, inductor, capacitor, resistor, switches, etc., may be disposed in the intermediary layer L2 or, more specifically, the cavity 110 of the intermediary layer L2. For example, in furtherance of implementing a respective power converter, the circuit 120 (such as including one or more circuit components) disposed in the intermediary layer L2 such as in cavity 110 is coupled between a first node N1 of the secondary winding 132 and a second node N2 of the secondary winding 132.

As further discussed herein, the novel multi-layer power converter assembly 110 and its different variations such as implementation of one or more circuit components in one or more intermediary layers provides new degrees of freedom with respect to implementation of secondary windings, paralleling them with primary windings and/or secondary windings, and reducing hence AC and DC resistances of circuit paths in a respective power converter assembly between the circuit 120 and the secondary winding 132. The multi-layer power converter assembly 100 as discussed herein supports more power dense transformers through vertical integration (such as stacking of multiple layers L1, L2, L3, etc., in the Z axis) rather than spreading into the X-Y plane through matrix transformer constructions.

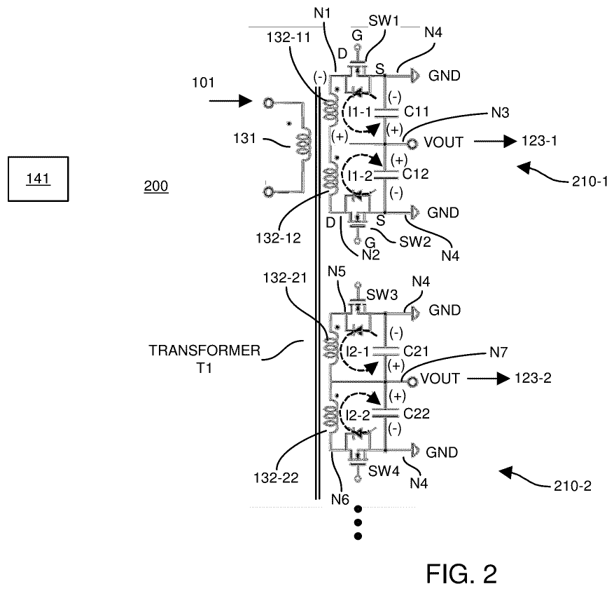

FIG. 2 is an example diagram illustrating a power converter circuit as discussed herein.

In this example, the power converter 200 includes transformer T1 including primary winding 131 as well as one or more pairs of secondary windings. For example, a first set of secondary windings includes secondary winding 132-11 and secondary winding 132-12 magnetically coupled to the primary winding 131; a second set of secondary windings includes the secondary winding 133-21 and secondary winding 133-22 magnetically coupled to the primary winding 131; and so on.

Note that the transformer T1 may be implemented as a matrix transformer having any number of identical secondary side switching cells. For example, primary windings may be connected in series while secondary windings may be connected in parallel to produce a common output voltage VOUT.

Each of multiple switching cells 210-1, 210-2, etc., associated with the circuit 210 may be a so-called current-doubler with two symmetrical elementary cells including one secondary winding, one synchronous rectification switch (such as one or more field effect transistors or other suitable types of switches), and an output capacitor. Each of the switches as discussed herein can be implemented as a field effect transistor or other suitable entity.

More specifically, in this example, switching cell 210-1 includes a first elementary cell including capacitor C11, switch SW1 (such as a rectifying switch), and secondary winding 132-11 connected in series via a loop configuration to support flow of current 11-1 and generation of output voltage 123-1 (or VOUT) at node N3; switching cell 210-1 also includes a second elementary cell including capacitor C12, switch SW2 (such as a rectifying switch), and secondary winding 132-12 connected in series via a loop configuration to support flow of current 11-2 and generation of output voltage 123-1 (or VOUT) at node N3.

Switching cell 210-2 includes a first elementary cell including capacitor C21, switch SW3, and secondary winding 132-21 connected in series via a loop configuration to support flow of current 12-1 and generation of output voltage 123-2 at node N7; switching cell 210-2 also includes a second elementary cell including capacitor C22, switch SW4, and secondary winding 132-22 connected in series via a loop configuration to support flow of current 12-2 and generation of output voltage 123-2 at node N7.

Note that each elementary cell can be optimized in a respective physical implementation of a multilayer power converter assembly. As previously discussed, flow of current 101 through the primary winding 131 and controlled switching of respective switches SW11, SW12, SW21, SW22, etc., via controller 141 causes corresponding flow of current through each of the secondary windings to produce one or more respective output voltages 123-1, 123-2, etc.

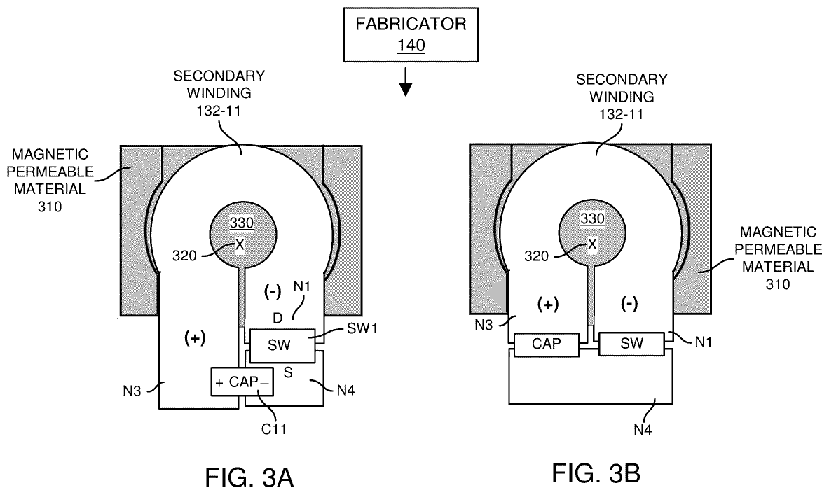

FIG. 3A illustrates a top view implementation of the multilayer power converter assembly 100 based on power converter 200. The circuit 120 disposed in the cavity 110 of the substrate 111 (intermediary layer L2) can be configured to include switch SW (such as switch SW1. SW2, SW3, etc.) and capacitor CAP (such as capacitor C11, C12, C13, etc.). Each instance of switch SW may be implemented as a vertical or horizontal switch. Each instance of the capacitor CAP may be implemented as a vertical or horizontal capacitor. The substrate 111 can be configured to include multiple cavities (such as one inlay or cavity for each component switch SW and capacitor CAP) or a single cavity (such as inlay) in which both the switch SW and capacitor CAP reside. Current through the primary winding causes creation of flux 330 in magnetic permeable material 310.

FIG. 3B is another implementation of circuit 200 and illustrates a top view implementation of a respective layer 3 of the multilayer power converter assembly 100. The circuit 120 disposed in the cavity 110 of the substrate 111 (intermediary layer 2) can be configured to include switch SW (such as switch SW1, SW2, SW3, etc.) and capacitor CAP (such as capacitor C11, C12, C13, etc.). Each instance of switch SW may be implemented as a vertical or horizontal switch. Each instance of the capacitor CAP may be implemented as a vertical or horizontal capacitor. The substrate 111 can be configured to include multiple cavities (such as one inlay or cavity for each component switch SW and capacitor CAP) or a single cavity (such as inlay) in which both the switch SW and capacitor CAP reside.

Thus, this disclosure includes the observation that it is desirable that the electric circuit of the elementary cell may need to be closed outside a respective magnetic core through synchronous rectification element (switch SW) and one or more output capacitors (capacitor CAP). According to conventional techniques, the state-of-the-art capacitors and synchronous elements are only placed on top and bottom layer of a respective PCB (Printed Circuit Board).

In contrast to conventional techniques, this disclosure includes closing secondary side windings within the PCB stack (such as assembly 100) itself rather than only on top and/or bottom layers. For example, this disclosure includes implementation of so-called an intermediary layer and corresponding inlay technology to integrate synchronous rectification devices and passive components within a specific layer of the secondary side windings. This disclosure further includes using two separate elements and separate inlays for each circuit such as switch SW or capacitor CAP (as shown in FIG. 3A) or integration of both the switch SW and capacitor CAP into one inlay as shown in FIG. 3B. Basically, such an inlay can be configured to include three load terminals and one control terminal to turn-on and turn-off the switch SW element.

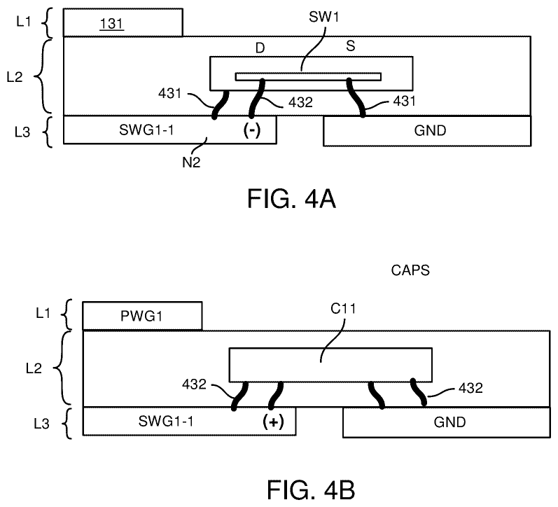

FIGS. 4A and 4B are example side view diagrams illustrating implementation of circuitry between a primary winding and a secondary winding as described herein.

FIG. 4A illustrates implementation of a respective switch SW1 disposed in the intermediary layer L2. Via circuit path 432, the drain D of the switch SW1 (such as lateral field effect transistor) is coupled to the mode N2 of the secondary winding in layer L3. The source node of the switch SW1 is connected to ground via the circuit path 431. Thus, an inlay arrangement includes connection of the two ends of the secondary winding to the GND load terminal through two lateral elements. Both elements may be integrated into one inlay as indicated by the blue line in FIG. 4b.

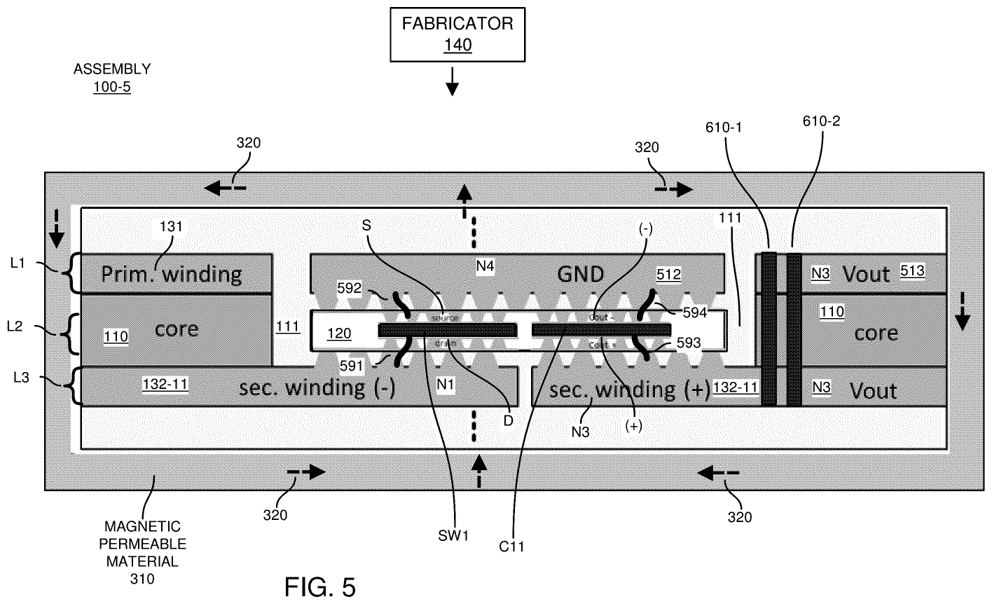

FIG. 5 is an example side view diagram illustrating implementation of power converter circuitry between a primary winding layer and a secondary winding layer is described herein.

In this example, the assembly 100-5 includes instantiation of a respective elementary cell 210-1 of the circuit 200 in FIG. 2. Assembly 100-5 includes switch SW11, secondary winding 132-11, and capacitor C11 associated with cell 210-1.

More specifically, the assembly 100-5 in FIG. 5 includes layer L1, layer L2, and layer L3. The layer L1 includes primary winding 131, conductive path 512 (connected to a ground reference potential or node N4), and a conductive path 513 connected to node N3 (output voltage node). The intermediary layer L2 includes a respective substrate 110 as well as a cavity 111 in which the circuit 120 resides. The circuit 120 includes a series connectivity of switch SW1 as well as capacitor C11. The layer L3 includes the secondary winding 132-11.

The intermediary layer L2 includes a substrate 110; the primary winding 131 may be affixed to a first surface of the substrate 110; the second winding 132-11 may be affixed to a second surface of the substrate 110.

As further shown, the circuit path 610-1 and the second circuit paths 610-2 (such as vias) provide connectivity between the layer L3 and the layer L1. The output voltage 123-1 generated by current 11-1 (associated with VOUT) is outputted from the node N3.

The circuit 120 and corresponding components switch SW1 and capacitor C11 disposed in the intermediary layer L2 are connected to elements in layer L1 and layer L3. For example, the drain node D of the switch SW1 is electrically connected to the negative terminal (−) of the secondary winding 132-11 via a first circuit path 591; the source node S of the switch SW1 is electrically connected to the circuit path 512 (such as GND or ground reference in layer L1) via a second circuit path 592; the positive terminal of the capacitor C11 is connected to the secondary winding 132-11 (node N3) via third circuit path 593; the negative terminal of the capacitor C11 is connected to the circuit path 512 via a third circuit path 594. Each of the circuit paths is an electrically conductive path fabricated from metal or other suitable material.

Accordingly, the intermediary layer L2 and corresponding connectivity as described herein provides unique short distance connectivity of the secondary winding 132-11 and corresponding components switch SW1 and capacitor C11.

In accordance with further example, the circuit 120 is a circuit assembly including a capacitor C11 and a switch SW1 disposed in series. The capacitor C11 is coupled in the circuit assembly between a first node N51 of the circuit 120 and a second node N52 of the circuit 120. The switch SW1 is coupled between the second node N52 of the circuit 120 and a third node N53 of the circuit 120. The first node N51 of the circuit 120 is directly coupled to the node N51 of the secondary winding 132-11. The third node N53 of the circuit 120 is directly coupled to the node N3 of the secondary winding 132-11. The circuit 120 includes a first facing (bottom surface) and a second facing (top surface). The first node N51 of the circuit 120 and the third node N53 of the circuit 120 are disposed on the first (bottom) facing of the circuit 120; the second node N52 of the circuit 120 is disposed on the second (top) facing of the circuit 120.

As further shown, note that the multi-layer power converter assembly 100-5 can be configured to include a respective magnetic permeable material 310 encasing at least a portion of the primary winding and secondary winding. The magnetic flux 320 generated by the primary winding 131 passes through the magnetic permeable material 310 as well as secondary winding 132-11. The presence of the magnetic flux 320 generated by the primary winding 131 causes a flow of current 11-1 through the secondary winding 132-11.

Note that each of the elementary cells in the circuit 200 of FIG. 2 can be implemented in a similar manner (in respective multiple layers) as shown in FIG. 5.

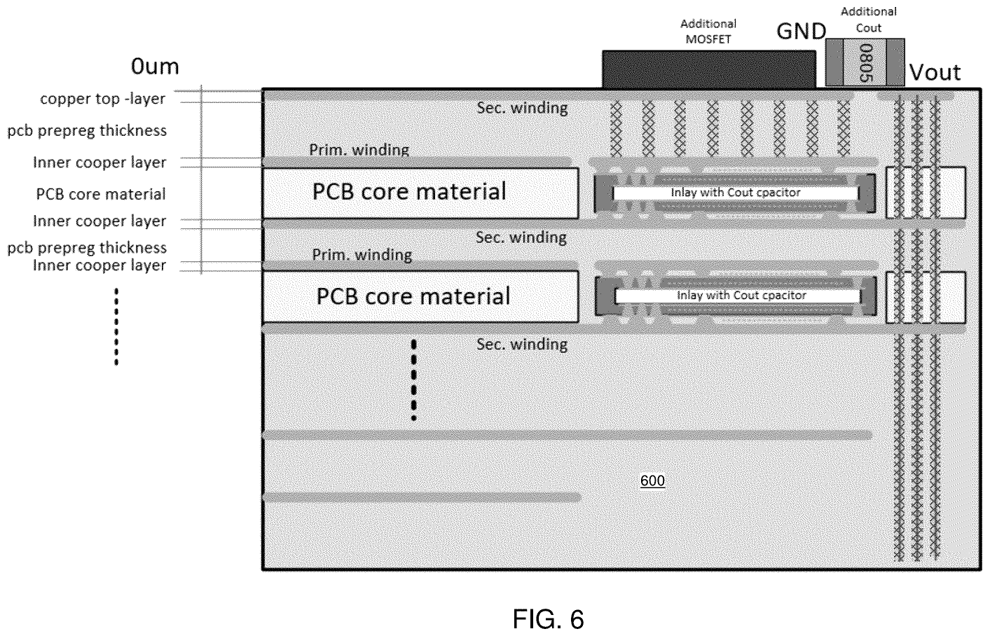

FIG. 6 is an example side view diagram illustrating implementation of multiple different primary and secondary winding layers to provide power conversion is described herein.

In this example, the power converter includes a vertical stack with two inlays (such as intermediary layers) within the PCB and a further secondary winding, Sync Rec MOSFETs and Output caps on the top layer to illustrate a configuration. The power converter 600 includes multi-parallel transformer secondary windings including inlay arrangement and discrete devices on the top layer.

It is noteworthy that the GND planes attached to the inlays can be geometrically arranged differently within the X-Y plane to allow perfect vertical routing both for GND and Vout.

Even though this disclosure includes an embedding of inlays within the PCB (Printed Circuit 4), it is understood and should not be construed in any way limiting that we can also integrate capacitors and power devices directly into the PCB using well known semiconductor Chip-embedding technologies.

The inlays may comprise beside load terminals further contacts for control signals. In a minimum configuration, there is one gate terminal to turn-on and turn-off Synchronous rectification devices. In additional examples, the multi-layer power converter assembly can be configured to include a Kelvin contact to tap precisely the voltage drop between Gate and Source without further voltage drops on the load terminals due to potential high currents or high di/dts (such change in magnitude of current).

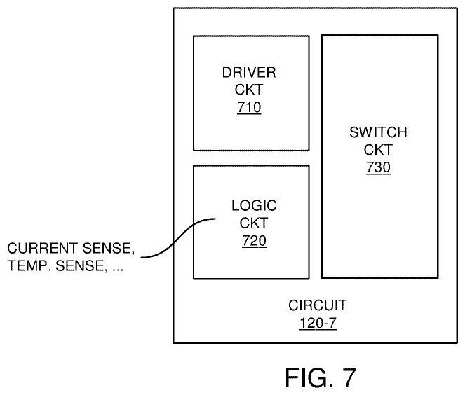

FIG. 7 is an example diagram illustrating different types of circuit populated in a respective inlay (cavity) or intermediary layer to provide power conversion as described herein.

Note that any of the intermediary layers as discussed herein can be configured to include any suitable circuit components.

For example, the inlay or intermediary layer as discussed herein can be configured to include current sensors. In yet another example, the intermediary layer (such as including inlay, cavity, etc.) as discussed herein comprises temperature sensors.

In a further example, the circuit 120-7 in the inlay or intermediary layer comprises gate driver functionality to control the synchronous rectification device. This control function may be passed to the inlay from a controller based on information such as the voltage drop between the load terminals or from information on switching of primary side transistors. In one configuration, the inlay comprises voltage sensing or current sensing and controls the turn-on and turn-off of synchronous rectification devices autonomous depending on either an information of current flow direction or voltage polarity across the load terminals.

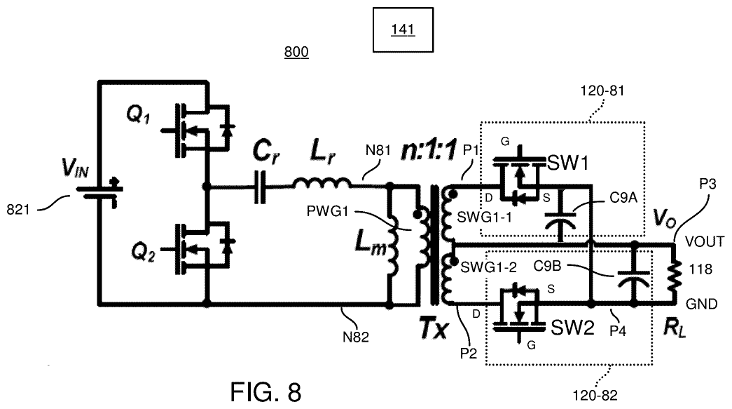

FIG. 8 is an example diagram illustrating a power converter circuitry as described herein.

In this example, the controller 141 controls operation of the example power converter circuitry 800. The power converter circuitry 800 includes primary side including components such as voltage source 821, switch Q1, switch Q2, capacitor CR, inductor LR, as well as primary winding PWG1 of transformer Tx. Secondary side of the power converter circuitry 800 includes switch SW1, switch SW2, capacitor C9A, capacitor C9B, secondary winding SWG1-1, and secondary winding SWG1-2.

Further in this example, the power converter circuitry 800 includes circuit 120-81 including switch SW1 and capacitor C9A. The power converter circuitry 800 further includes the circuit 120-82 including switch SW2 and capacitor C9B. The following drawings illustrate implementation of the power converter circuitry 800 and corresponding circuitry 120-81 and 120-82 in one or more intermediary layers of a multilayer power converter assembly.

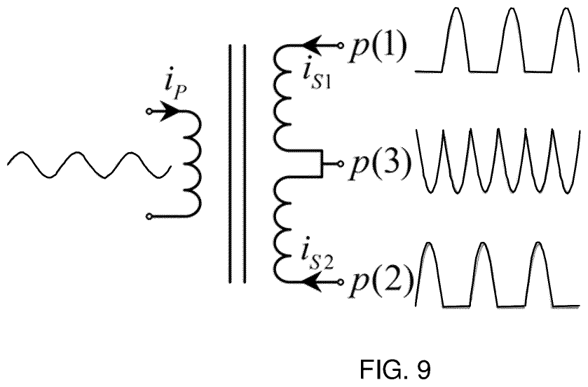

FIG. 9 is an example diagram illustrating current flow through different windings of the power converter circuitry as described herein.

The topology of the selected transformer with a center tap is symmetrical on both sides, as shown in FIG. 8, where iP (current through the primary winding PWG1) and iS1 (current through the first secondary winding SWG1-1) and iS2 (current through the second secondary winding SWG1-2) represent the primary and secondary side currents of two connected SR MOSFETs, respectively; p(1) and p(2) stand for two equipotential points between the PT and SR device; and p(3) stand for the equipotential point of the center tap.

Currents iS1 and iS2 can be decomposed into DC components, odd-order AC components that can cause the connection loss of p(1) and p(2), and even-order AC components that can cause the connection loss of p(1) and p(3). In addition, the DC component and even-order AC component of iS2 can cause the connection loss of p(2) and p(3).

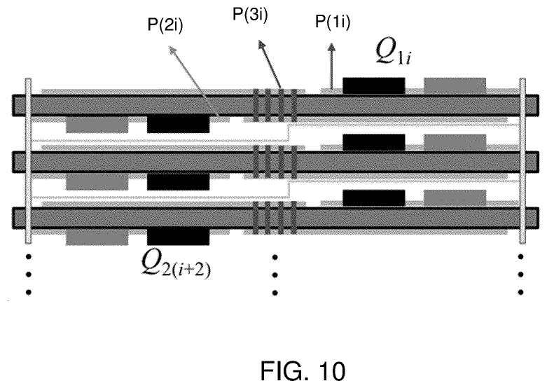

FIG. 10 is an example side view diagram illustrating stacking of multiple different power converter circuitry is to provide power conversion as described herein.

The multi-layer power converter assembly 1000 (such as instantiation of the circuit 800 in FIG. 8) includes discreet placement of parallel planar center taped transformer windings and corresponding complements in a stacked manner as further discussed in the following drawings.

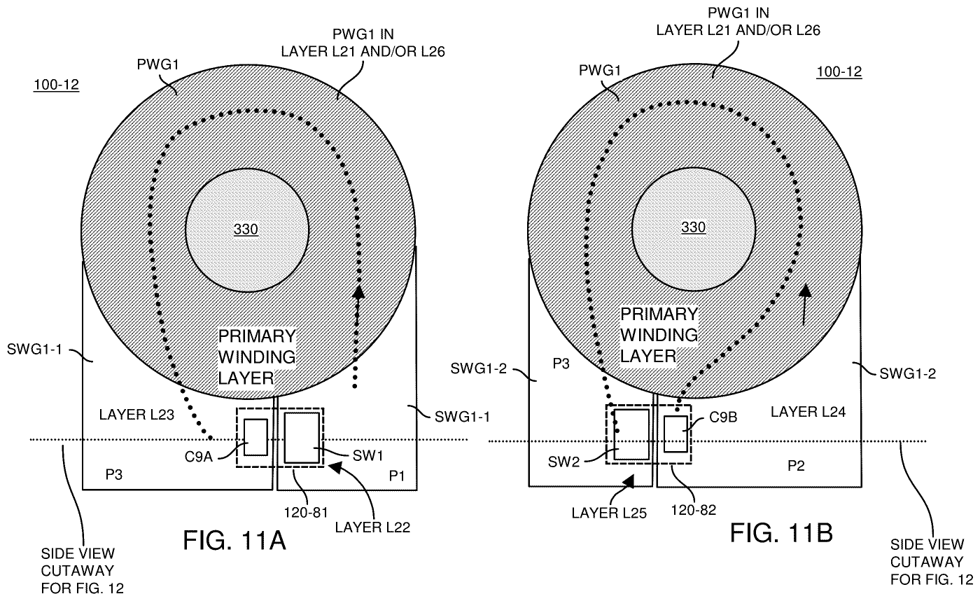

FIG. 11A is an example top view diagram of different layers of a multi-layer power converter assembly as described herein.

In this example, the power converter circuitry 800 of FIG. 8 is implemented as a multilayer power converter assembly 100-12, a portion of which is shown in FIG. 11A. For example, FIG. 11A illustrates a top view illustrating the primary winding PWG1 associated the circuit 800 as disposed in one or more of layer L21 and/or L26 of the multi-layer power converter assembly 100-12.

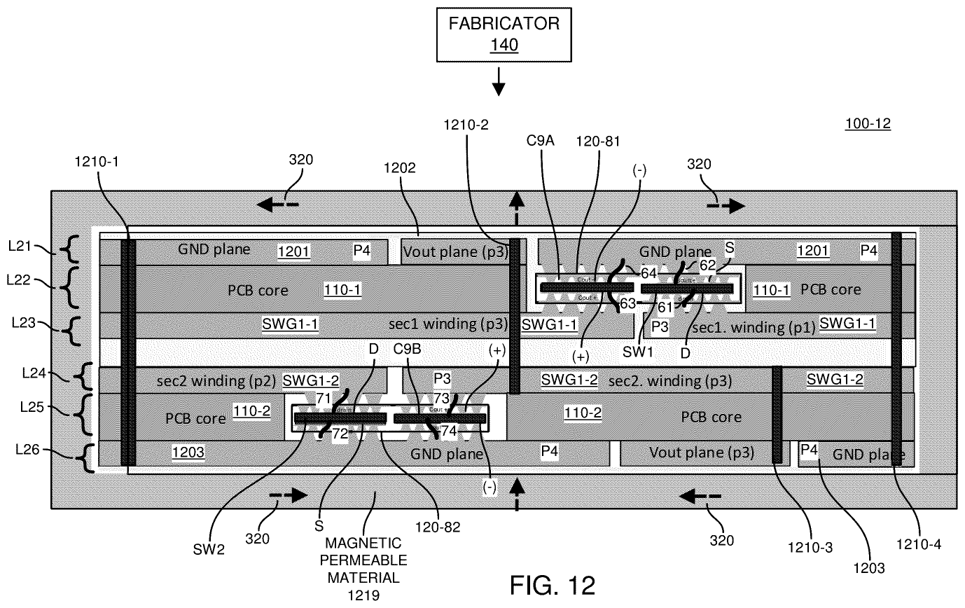

Further, intermediary layer L23 of the multi-layer power converter assembly 100-12 includes a secondary winding SWG1-1 extending between node P3 and node P1. The circuit 120-81 such as a combination of switch SW1 and capacitor C9A is disposed in an intermediary layer L22 of the multilayer power converter assembly 100-12. The side cutaway view of the multi-layer power converter assembly 100-12 is shown in FIG. 12.

FIG. 11B is an example top view diagram of different layers of a multi-layer power converter assembly as described herein.

As previously discussed, the power converter circuitry 800 of FIG. 8 is implemented as a multilayer power converter assembly 100-12, a portion of which is shown in FIG. 11B. See FIG. 12. For example, FIG. 11B illustrates a top view illustrating the primary winding PWG1 associated the circuit 800 as disposed in one or more of layer L21 and L26 of the multi-layer power converter assembly 100-12.

Further, intermediary layer L26 of the multi-layer power converter assembly 100-12 includes a secondary winding SWG1-2 extending between node P2 and node P3. The circuit 120-82 such as a combination of switch SW2 and capacitor C9B is disposed in the intermediary layer L25 of the multilayer power converter assembly 100-12. The side cutaway view of the multi-layer power converter assembly 100-12 is shown in FIG. 12.

FIG. 12 is an example side view diagram illustrating implementation of multiple cavities at different layers of a power converter assembly to provide power conversion described herein.

In this example, the assembly 100-12 of FIG. 12 includes instantiation of a respective cell of the circuit 800 in FIG. 8. Assembly 100-12 includes circuit 120-81 in intermediary layer L22. Circuit 120-81 in the intermediary layer L22 includes switch SW11 and capacitor C11 connected in series.

More specifically, the multi-layer power converter assembly 100-12 includes layer L21, L22, and layer L23. The layer L21 includes primary winding PWG1, ground plane 1201, and output voltage plane 1202 (node P3).

The intermediary layer L22 includes a respective substrate 110 as well as a cavity in which the circuit 120-81 resides. The circuit 120-81 includes a series connectivity of switch SW1 as well as capacitor C9A.

The layer L23 includes the secondary winding SWG1-1.

As further shown, the circuit path 1210-1 such as a via provides connectivity of the ground plane in layer L21 to the ground plane in layer L26. The circuit path 1210-2 such as a via provides connectivity between the secondary winding SWG1-2 in layer L24 and the output voltage plane (node P3). The circuit path 1210-3 such as a via provides connectivity between the secondary winding SWG1-2 in layer L24 and the output voltage plane in layer L26. The circuit path 1210-4 also provides connectivity of the ground plane in layer L21 to the ground plane in layer L26.

The output voltage Vout of the power converter circuitry 800 is outputted from the output voltage plane in layer L21 and layer 26 (node P3).

As further shown, the circuit 120-81 and corresponding components switch SW1 (such as a vertical transistor) and capacitor C9A (such as a vertical capacitor) disposed in the intermediary layer L22 are connected to components in layer L21 and layer L23. For example, the drain node D of the switch SW1 is electrically connected to the node P1 of the secondary winding SWG1-1 via circuit path 61; the source node of the switch SW1 is electrically connected to the ground plane in the layer L21 (ground plane 1201) via circuit path 62; the positive terminal of the capacitor C9A is connected to the node P3 of the secondary winding SWG1-1 via circuit path 63; the negative terminal of the capacitor C9A is connected to the ground plane (P4) in layer L21 via circuit path 64. Each of the circuit paths is an electrically conductive path fabricated from metal or other suitable material.

Accordingly, the intermediary layer L22 and corresponding connectivity as described herein provides unique short distance connectivity of the secondary winding SWG1-1 and corresponding components switch SW1 and capacitor C9A.

As further shown, the circuit 120-82 and corresponding components switch SW2 and capacitor C9B disposed in the intermediary layer L25 are connected to components in layer L24 and layer L26. For example, the drain node D of the switch SW2 is electrically connected to the node P2 of the secondary winding SWG1-2 via circuit path 71; the source node S of the switch SW2 is electrically connected to the ground plane in the layer L26 via circuit path 72; the positive terminal of the capacitor C9B is connected to the node P3 of the secondary winding SWG1-2 via circuit path 73; the negative terminal of the capacitor C9B is connected to the ground plane (node P4) in layer L26 via circuit path 74.

Each of the circuit paths as discussed herein is an electrically conductive path fabricated from metal or other suitable material.

Accordingly, the intermediary layer L25 and corresponding connectivity as described herein provides unique short distance connectivity of the secondary winding SWG1-2 and corresponding components switch SW2 and capacitor C9B.

As further shown, note that the assembly 100-12 can be configured to include a respective magnetic permeable material 1219 encasing at least a portion of the primary winding and secondary winding. The magnetic flux 1220 generated by the magnetic permeable core of the primary winding PWG1 passes through the magnetic permeable material 1219 as well as secondary windings SWG1-1 and SWG1-2. The presence of the magnetic flux 1220 generated by the primary winding PWG1 causes a flow of currents through the first secondary winding SWG1-1 and second secondary switching SWG1-2 in a manner as previously discussed.

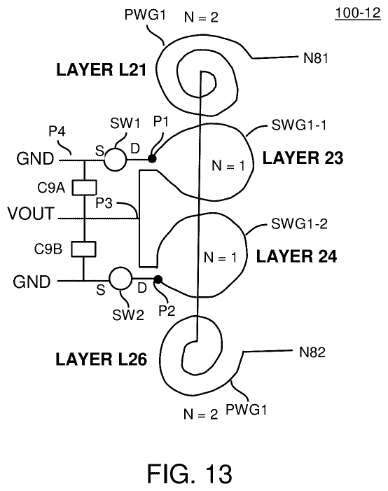

FIG. 13 is an example top view diagram illustrating different layers of a respective power converter assembly and corresponding logical connectivity of circuitry as described herein.

In this example, each of the windings is spread apart to illustrate logical connectivity associated with the multilayer power converter assembly 100-12. In the actual implementation, as previously discussed in FIG. 12, the primary winding PWG1, first secondary winding SWG1-1, and second secondary winding SWG1-2 are aligned with each other and core magnetic permeable material passing through a center of each of the windings PWG1, SWG1-1, SWG1-2 as opposed to being spaced apart shown in FIG. 13.

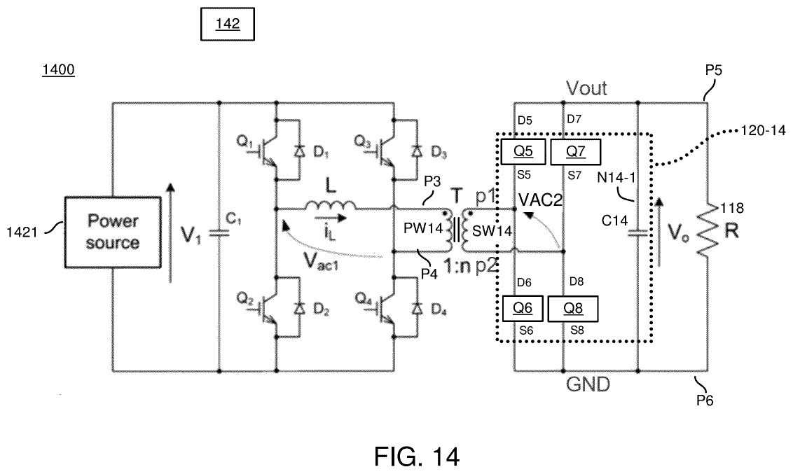

FIG. 14 is an example diagram of a power converter circuit as described herein.

In this example, the controller 142 controls operation of the power converter circuitry 1400 and corresponding switches.

As shown, the primary side of power converter circuitry 1400 includes components such as voltage source 1421, switch Q1, switch Q2, switch Q3, switch Q4, inductor L, as well as primary winding PW14 of transformer T. The secondary side of the power converter circuitry 1400 includes secondary winding SW14 of transformer T, switch Q5, switch Q6, switch Q7, and switch Q8, and capacitor C14. The secondary side of the circuit 1400 produces the respective voltage Vout to power the corresponding load 118.

Circuit 120-14 therefore includes switch Q5, switch Q6, switch Q7, switch Q8, and capacitor C14. Note that the switches Q5 through Q8 can be replaced with appropriate diodes to provide rectification of the respective AC voltage VAC2 produced by the secondary winding SW14. The rectification of the respective voltage VAC2 results in generation of a respective DC voltage VOUT.

The following drawings illustrate implementation of the power converter circuitry 1400 and corresponding circuitry 120-14 in a multilayer power converter assembly.

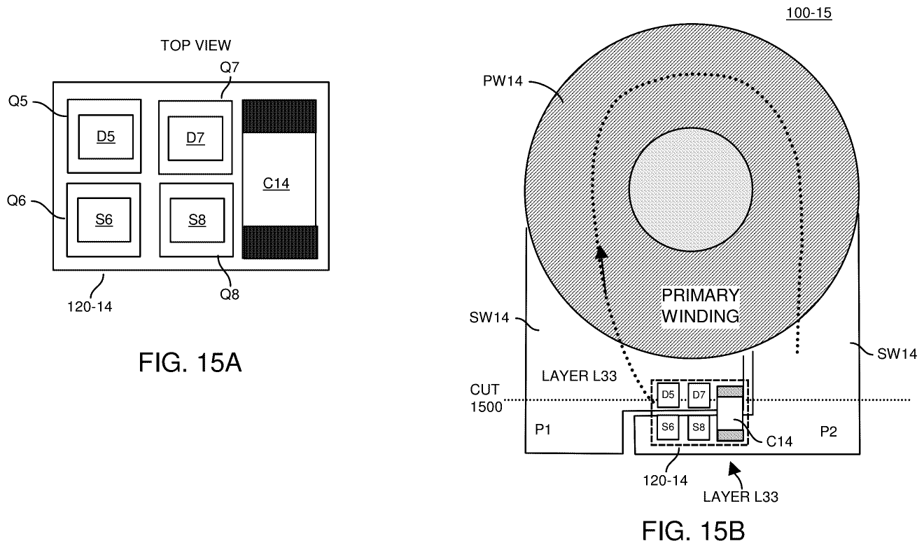

FIG. 15A is an example top view diagram (top surface view) of a circuitry implemented in an intermediary layer of a multilayer power converter assembly as discussed herein.

In this example, the circuitry 120-14 includes a respective switch Q5, switch Q6, switch Q7, switch Q8, and capacitor C14. Capacitor C14 is a horizontal capacitor.

Each of the switches Q5 to Q8 are implemented as vertical transistors.

The drain node D5 of switch Q5 is exposed on the top surface of the circuit 120-14; the source node S5 of switch Q5 is exposed on a bottom surface of the circuit 120-14.

The source node S6 of switch Q6 is exposed on the top surface of the circuit 120-14; the drain node D6 of switch Q6 is exposed on a bottom surface of the circuit 120-14.

The drain node D7 of switch Q7 is exposed on the top surface of the circuit 120-14; the source node S7 of switch Q7 is exposed on a bottom surface of the circuit 120-14.

The source node S8 of switch Q8 is exposed on the top surface of the circuit 120-14; the drain node D8 of switch Q8 is exposed on a bottom surface of the circuit 120-14.

FIG. 15B is an example top view diagram of multiple layers of a multilayer power converter assembly as discussed herein.

As previously discussed, the power converter circuitry 1400 of FIG. 14 is implemented as a multilayer power converter assembly 100-14, a portion of which is shown in FIG. 15B. For example, FIG. 15B illustrates a top view illustrating the primary winding PW14 associated the circuit 1400 as disposed in layer L31 and/or L35 of the multi-layer power converter assembly 100-14.

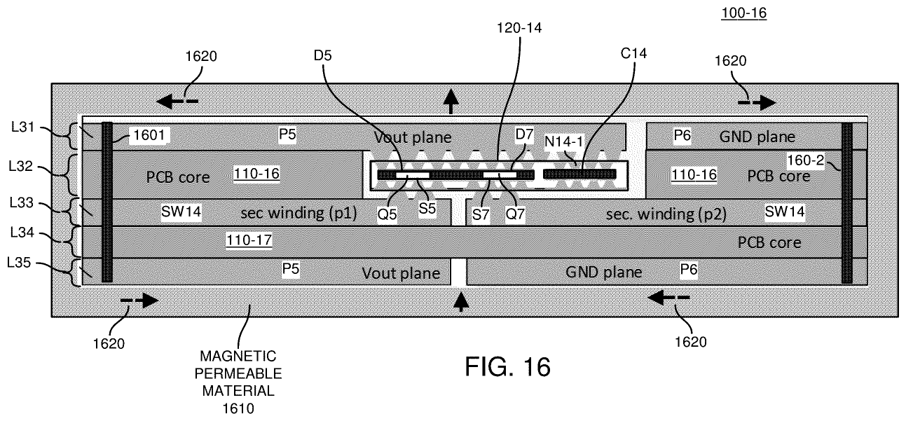

Further, intermediary layer L32 of the multi-layer power converter assembly 100-14 includes a secondary winding SW14 extending between node P1 and node P2 power converter circuitry 1400. The circuit 120-14 such as a combination of switch switches and horizontal capacitor C14 is disposed in the intermediary layer L32 of the multilayer power converter assembly 100-12. The side cutaway view of the multi-layer power converter assembly 100-12 along cut 1500 is shown in FIG. 16.

FIG. 16 is an example side view diagram illustrating implementation of an intermediary layer to implement a power converter assembly as described herein.

In this example, the assembly 100-16 includes instantiation of the power converter circuit 1400 in FIG. 14. Assembly 100-14 includes circuit 120-14 disposed in intermediary layer L32. Circuit 120-14 in the intermediary layer L32 includes switches Q5-Q8 and capacitor C14 connected in a manner as shown in power converter circuit 1400.

More specifically, the multi-layer power converter assembly 100-16 includes layer L31, L32, layer L33, layer L34, and layer L35. The layer L31 and/or layer L35 include implementation of primary winding PWG14, ground plane 1401 (node P6), and output voltage plane 1402 (node P5). The intermediary layer L32 may include a respective substrate 110-16 as well as a cavity in which the circuit 120-14 resides. The layer L33 includes the secondary winding SW14. The layer L34 may include a respective substrate 110-17.

As further shown, the drain node D5 disposed on a top surface of switch Q5 is connected to the VOUT plane (node P5) via a circuit path; the source node S5 disposed on a bottom surface of switch Q5 is connected to the node P1 of the secondary winding SW14. The drain node D7 disposed on a top surface of switch Q7 is connected to the VOUT plane (node P5); the source node S7 disposed on a bottom surface of switch Q7 is connected to the node P2 of the secondary winding SW14. The terminal end node N14-1 (positive side) of capacitor C14 is coupled to the node P5 of the power converter circuitry 100-14.

Accordingly, the intermediary layer L32 and corresponding connectivity as described herein provides unique short distance connectivity of the secondary winding SW14 and corresponding components switches Q5-Q8 and capacitor C14.

In a similar manner as previously discussed, note that the assembly 100-16 can be configured to include a respective magnetic permeable material 1610 encasing at least a portion of the primary winding and secondary winding. A portion of the magnetic permeable material 1610 passes through each of the primary winding PW14 and second winding SW14. The magnetic flux 1620 generated by the primary winding PW14 passes through the magnetic permeable material 1610 as well as secondary winding SW14. The presence of the magnetic flux 1620 generated by the primary winding PW14 causes a flow of current through the secondary winding SW14 to produce the output voltage VOUT that powers the load 118 (FIG. 14).

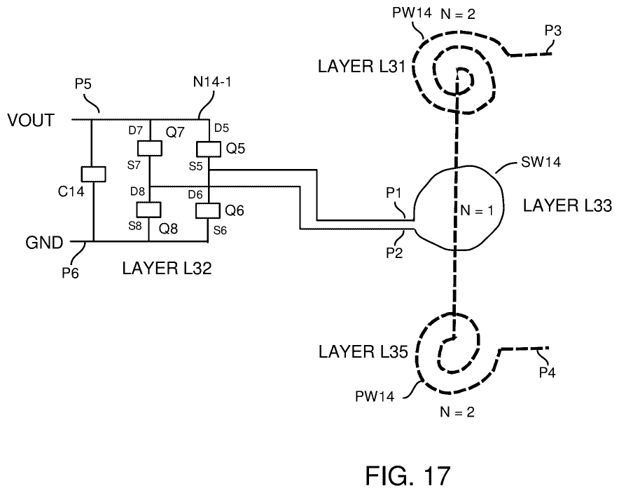

FIG. 17 is an example top view diagram illustrating different layers of a respective power converter assembly and corresponding circuitry as described herein.

In this example, each of the windings is spread apart to illustrate logical connectivity associated with the multilayer power converter assembly 100-16. In the actual implementation, as previously discussed in FIG. 16, the primary winding PW14 and secondary winding SW14 are aligned with each other as opposed to being spaced apart shown in FIG. 17.

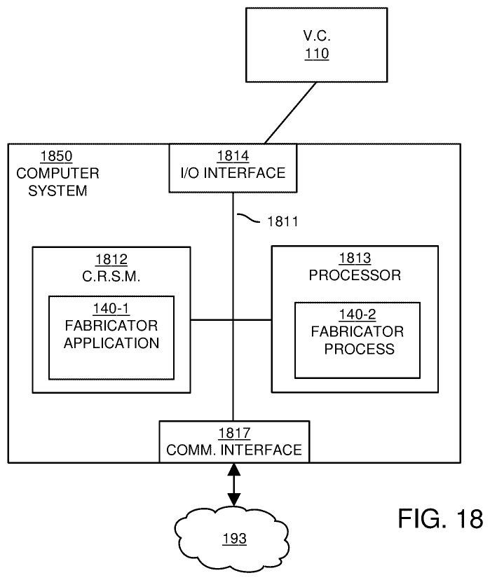

FIG. 18 is an example block diagram of a computer system for implementing any of the operations as previously discussed.

Any of the resources (such as fabricator 140, etc.) as discussed herein can be configured to include computer processor hardware and/or corresponding executable instructions to carry out the different operations as discussed herein.

As shown, computer system 1850 of the present example includes an interconnect 1811 that couples computer readable storage media 1812 such as a non-transitory type of media (which can be any suitable type of hardware storage medium in which digital information can be stored and retrieved), a processor 1813 (computer processor hardware), I/O interface 1814, and a communications interface 1817.

I/O interface(s) 1814 supports connectivity to voltage converter 110.

Computer readable storage medium 1812 can be any hardware storage device such as memory, optical storage, hard drive, floppy disk, etc. The computer readable storage medium 1812 may store instructions and/or data.

As shown, computer readable storage media 1812 can be encoded with fabricator application 140-1 (e.g., including instructions) to carry out any of the operations as discussed herein.

During operation, processor 1813 accesses computer readable storage media 1812 via the use of interconnect 1811 in order to launch, run, execute, interpret or otherwise perform the instructions in fabricator application 140-1 stored on computer readable storage medium 1812. Execution of the fabricator application 140-1 produces fabricator process 140-2 to carry out any of the operations and/or processes as discussed herein.

Those skilled in the art will understand that the computer system 1850 can include other processes and/or software and hardware components, such as an operating system that controls allocation and use of hardware resources to execute fabricator application 140-1.

Note that computer system may reside in any of various types of devices, including, but not limited to, a power supply, switched-capacitor converter, power converter, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1850 may reside at any location or can be included in any suitable resource in any network environment to implement functionality as discussed herein.

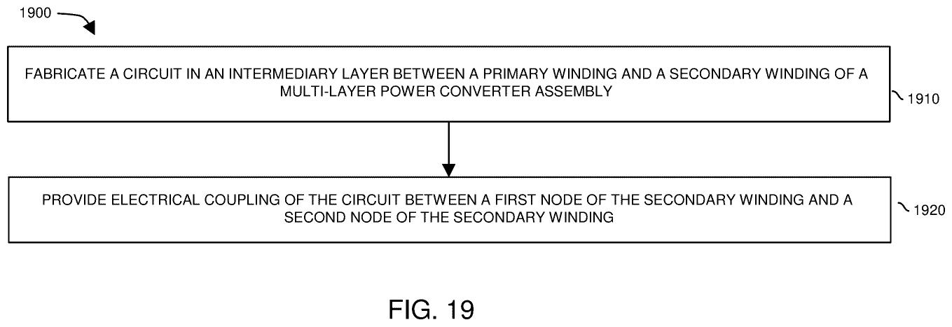

Functionality supported by the different resources will now be discussed via flowcharts in FIG. 19. Note that the steps in the flowcharts below can be executed in any suitable order.

FIG. 19 is a flowchart 1900 illustrating an example method as discussed herein. Note that there will be some overlap with respect to concepts as discussed above.

In processing operation 1910, the fabricator 140 fabricates a circuit 120 in an intermediary layer L2 between a primary winding 131 and a secondary winding 132 of a multi-layer power converter assembly 100.

In processing operation 1920, the fabricator 140 provides electrical coupling of the circuit 120 between a first node N1 of the secondary winding 132 and a second node N2 of the secondary winding 132.

Note again that techniques herein are well suited for use in power converter assemblies. However, it should be noted that the examples herein are not limited to use in such applications and that the techniques discussed herein are well suited for other applications as well.

While this invention has been particularly shown and described with references to preferred configurations thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A multi-layer transformer assembly comprising:
a primary winding;
a secondary winding magnetically coupled to the primary winding;
an intermediary layer disposed between the primary winding and the secondary winding; and
a circuit disposed in the intermediary layer, the circuit electrically coupled to the secondary winding.

2. The multi-layer transformer assembly as in claim 1, wherein the circuit is directly coupled between a first node of the secondary winding and a second node of the secondary winding.

3. The multi-layer transformer assembly as in claim 1, wherein the circuit is operative to control a flow of current through the secondary winding.

4. The multi-layer transformer assembly as in claim 1, wherein the circuit includes a capacitor and a switch disposed in series;
wherein the capacitor is coupled between a first node of the circuit and a second node of the circuit;
wherein the switch is coupled between the second node of the circuit and a third node of the circuit;
wherein the first node of the circuit is directly coupled to a first node of the secondary winding; and
wherein the third node of the circuit is directly coupled to a second node of the secondary winding.

5. The multi-layer transformer assembly as in claim 4, wherein the circuit includes a first facing and a second facing;
wherein the first node of the circuit and the third node of the circuit are disposed on the first facing of the circuit; and
wherein the second node of the circuit is disposed on the second facing of the circuit, the second facing opposite the first facing.

6. The multi-layer transformer assembly as in claim 1, wherein the circuit includes a vertical capacitor and a vertical field effect transistor.

7. The multi-layer transformer assembly as in claim 6, wherein a first node of the vertical capacitor is directly coupled to a first node of the switch via an electrically conductive path;
wherein a second node of the vertical capacitor is directly coupled to a first node of the secondary winding; and
wherein a second node of the vertical switch is directly coupled to the second node of the secondary winding.

8. The multi-layer transformer assembly as in claim 7, wherein the primary winding resides within a first plane;
wherein the second winding resides within a second plane, the second plane substantially parallel to the first plane;
wherein the intermediary layer resides between the first plane and the second plane.

9. The multi-layer transformer assembly as in claim 1, wherein the circuit includes a capacitor and a switch; and
wherein a combination of the secondary winding, the switch, and the capacitor are connected in series.

10. The multi-layer transformer assembly as in claim 9, wherein the combination of the secondary winding, the switch, and the capacitor form a series circuit loop.

11. The multi-layer transformer assembly as in claim 1, wherein the intermediary layer includes a substrate;
wherein the primary winding is affixed to a first surface of the substrate; and
wherein the secondary winding is affixed to a second surface of the substrate.

12. The multi-layer transformer assembly as in claim 1 further comprising:
a core of magnetic permeable material passing through the intermediary layer;
wherein the primary winding is wrapped around the core; and
wherein the secondary winding is wrapped around the core.

13. The multi-layer transformer assembly as in claim 1, wherein the intermediary layer includes a substrate, the circuit disposed in an inlay of the substrate.

14. The multi-layer transformer assembly as in claim 1 further comprising:
a reference voltage node disposed in a circuit layer in which the primary winding resides; and
wherein the circuit is disposed between the reference voltage node and the secondary winding.

15. The multi-layer transformer assembly as in claim 1 further comprising:
a reference voltage node disposed in a circuit layer in which the primary winding resides, the reference node not electrically connected to the primary winding;
wherein the circuit includes a first circuit component, a first surface node of the first circuit component electrically coupled directly to the reference voltage node, a second surface node of the first circuit component electrically coupled directly to the secondary winding.

16. A multiple-layer transformer assembly comprising:
a primary winding;
a first secondary winding magnetically coupled to the primary winding;
a second secondary winding magnetically coupled to the primary winding;
a first substrate separating the primary winding and the first secondary winding, the first substrate including a first inlay;
a first circuit disposed in the first inlay;
a second substrate separating the primary winding and the second secondary winding, the second substrate including a second inlay; and
a second circuit disposed in the second inlay.

17. The multi-layer transformer assembly as in claim 16, wherein the primary winding includes a first primary winding portion electrically coupled to a second primary winding portion; and
wherein the first substrate and the second substrate are disposed between the first primary winding portion and the second primary winding portion.

18. The multi-layer transformer assembly as in claim 16, wherein the first circuit includes a first switch, control of the first switch operative to produce an output voltage via first current supplied by the first secondary winding; and
wherein the second circuit includes a second switch, control of the second switch operative to produce the output voltage via second current supplied by the second secondary winding.

19. The multi-layer transformer assembly as in claim 16 further comprising:
a circuit path operative to directly connect the first secondary winding and the second secondary winding in series.

20. A method comprising:
fabricating an intermediary layer between a primary winding and a secondary winding of a multi-layer transformer assembly to include a circuit operative to control flow of current through the secondary winding; and
providing electrical coupling of the circuit between a first node of the secondary winding and a second node of the secondary winding.
